(19) United States
(12) Patent Application Publication
(10) Pub. No.: US 2019/0187828 A1
(43) Pub. Date: Jun. 20, 2019

(54) LOCATION DETECTION FOR A TOUCH SYSTEM

(71) Applicant: TEXAS INSTRUMENTS INCORPORATED, Dallas, TX (US)

(72) Inventors: SRINATH HOSUR, Plano, TX (US); Ashish Khandelwal, IRVING, TX (US)

(21) Appl. No.: 15/843,661

(22) Filed: Dec. 15, 2017

(51) Int. Cl. G06F 3/044

(52) U.S. Cl. CPC G06F 3/044

(57) ABSTRACT

A system includes a receiver to receive output signals from a touch system to detect a user's touch. The output signals are received in response to excitation signals that are generated out of phase with respect to each other and applied to at least two rows or columns of the touch system. A touch location analyzer compares an amplitude of the output signals received from the rows or columns of the touch system, where a ratio of the output signal amplitudes from the rows or columns of the touch system is utilized to determine the location of the user's touch relative to the rows or columns of the touch system.

### TECHNICAL FIELD

This relates generally to integrated circuits, and more particularly to estimating a touch location in a touch system.

### BACKGROUND

A touch system includes interfaces such as touch screens that can include an input device and output device layered on top of an electronic visual display of an information processing system. For example, a user can provide input or control the information processing system through simple or multi-touch gestures by touching the screen with a special stylus and/or one or more fingers. Touch screens are common in devices, such as game consoles, personal computers, tablet computers, electronic voting machines, and smart phones. These interfaces can also be attached to computers or, as terminals, to networks.

To detect user gestures such as touching via the touch system interface, common technologies include resistive touch screens and capacitive touch screens can be employed. An example capacitive touch screen panel consists of an insulator such as glass, coated with a transparent conductor such as indium tin oxide. As the human body is also an electrical conductor, touching the surface of the screen results in a distortion of the screen's electrostatic field, measurable as a change in capacitance. Different technologies may be used to determine the location of the touch. In some touch systems, mutual or self capacitance can be measured by transmitting a signal on a row/column of the touch screen interface and receiving the signal on a respective column/row. When the touch occurs close to a row/column intersection, the received change in signal strength and/or signal phase changes. This change isolates the touch location.

### SUMMARY

In an example, a system includes a receiver to receive output signals from a touch system to detect a user's touch. The output signals are received in response to excitation signals that are generated out of phase with respect to each other and applied to at least two rows or columns of the touch system. A touch location analyzer compares an amplitude of the output signals received from the rows or columns of the touch system, where a ratio of the output signal amplitudes from the rows or columns of the touch system is utilized to determine the location of the user's touch relative to the rows or columns of the touch system.

In another example, a receiver receives output signals from a touch system to detect a user's touch. The output signals are received in response to at least two out of phase excitation signals applied to at least two rows or columns of the touch system. A touch location analyzer compares the phase of the output signals received from different rows or columns of the touch system. A difference in phase of the output signal amplitudes from the rows or columns of the touch system is utilized to determine the location of the user's touch relative to the rows or columns of the touch system.

In yet another example, a method includes transmitting excitation signals that are out of phase with respect to each other to a touch system. At least one of the excitation signals is transmitted to at least one row or column of the touch system and at least one other of the excitation signals is concurrently transmitted to at least one other row or column of the touch system. The method includes receiving output signals from the touch system in response to the excitation signals. The output signal includes a combined response from two or more rows or columns of the touch system excited by the excitation signals. The method includes comparing the amplitude or phase of the output signals received from different rows or columns of the touch system to determine a difference in the amplitude or phase of the output signal from the different rows or columns of the touch system to determine the location of the user's touch relative to the rows or columns of the touch system.

### BRIEF DESCRIPTION OF THE DRAWINGS

FIG. 1 is a schematic block diagram of an example system to determine touch location of a touch system.

FIG. 2 is a circuit diagram of a receiver and transmitter for an example touch system that uses multiphase signaling and processing.

FIG. 3 is a circuit diagram of an example touch system that can be excited and analyzed via multiphase signaling to determine touch location.

FIG. 4 is a circuit diagram of an example transmitter and receiver circuit that uses multiphase signaling and processing to determine touch location.

FIG. 5 is a flow diagram of an example method to determine touch location of a touch system.

### DETAILED DESCRIPTION

In example embodiments, received signals from a touch system are analyzed with respect to signal amplitude and/or phase to determine a location of a user's touch relative to the rows or columns of the touch system. A receiver receives output signals (or signal) from the touch system to detect the user's touch. The output signals are received in response to excitation signals that are generated out of phase with respect to each other and applied to at least two rows or columns of the touch system. In some examples, out of phase excitation signals can be applied concurrently to the rows or columns of the touch system to decrease the amount of scan time it takes to receive a response to the excitation signals. Also, by concurrently analyzing multiple touch locations in response to the out of phase excitation signals, receiving hardware to determine the user's touch can be simplified. A touch location analyzer compares an amplitude of the output signals received from different rows or columns of the touch system. A ratio of the output signal amplitudes from the different rows or columns of the touch system is utilized to determine the location of the user's touch relative to the rows or columns of the touch system. In another example, received signal phases from different rows or columns of the touch system are analyzed to determine the location of the user's touch.

By analyzing the respective amplitudes and/or phases received in response to a user's touch of the touch system, precise location of the touch can be determined which includes determining touch locations between rows and/or columns of the touch system. For example, if a stylus (or finger) is placed at a touch location that is directly over a row/column detection point, a maximum signal amplitude may be received for that point. If the stylus is offset to touch/affect more than one row or column detection point of the touch system, a combination of signal amplitudes or phases can be analyzed to detect locations between rows or columns. Thus, if one row yields a signal at 70% of maximum, and another row provides a signal that is 30% of maximum, it can be determined that the stylus is offset from the center of one row in the direction toward about 30% of the other row.

The touch system can be excited by a transmitter that transmits excitation signals that are out of phase with respect to each other (e.g., a sine wave generated as one excitation signal and a cosine wave generated as another excitation signal). At least one of the of excitation signals is transmitted to at least one row or column of a touch system and at least one other of the excitation signals is concurrently transmitted to at least one other row or column of the touch system. An output signal having a combination of signals from each of the excitation signals is received by a receiver in response to the excitation signals transmitted to the touch system. Receiver circuits extrapolate the row or column information from the output signal based on the phase of the excitation signals. For example, in a two phase excitation system, at least two receiver circuits include a summing junction to extrapolate signal phases from the output signal to determine which of at least two rows or columns was touched.

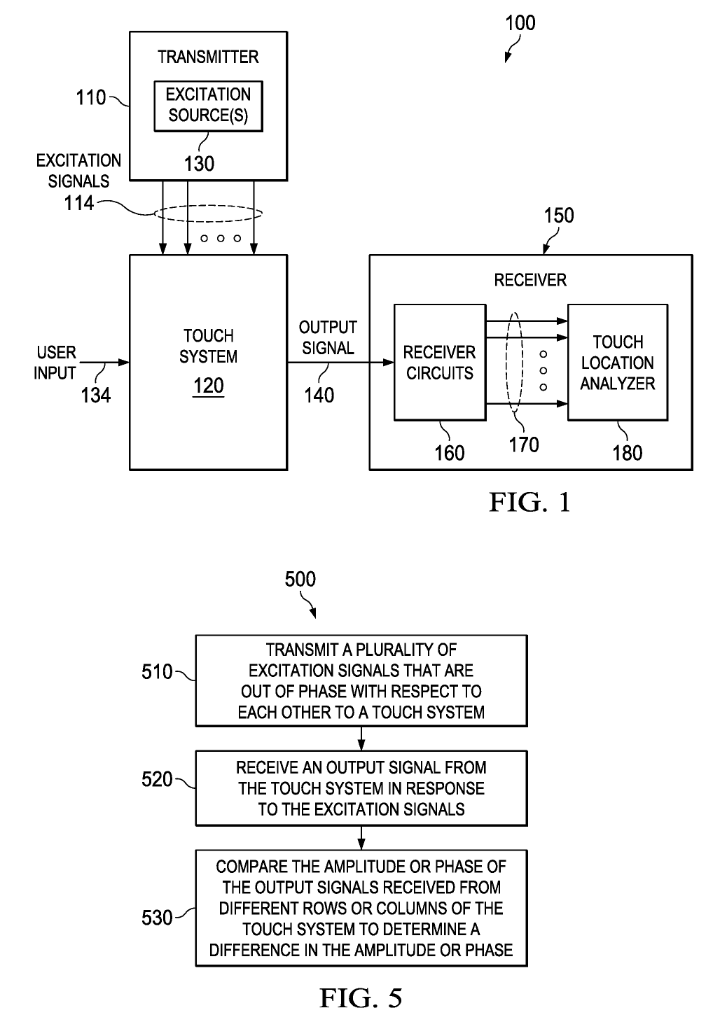

FIG. 1 illustrates an example system 100 to touch location of a touch system. The system 100 includes a transmitter 110 to transmit excitation signals 114. At least one of the excitation signals 114 can be transmitted to at least one row or column of a touch system 120 and at least one other of the excitation signals can be concurrently transmitted to at least one other row or column of the touch system. In some examples, individual excitation can be provided where one row or column is excited and in a subsequent scanning sequence another row or column of the touch system 120. The transmitter 110 generates at least one of the excitation signals 114 at a given phase to one row or column of the touch system 120 and generates the other of the excitation signals at a different phase from the given phase to the other row or column of the touch system. For example, one excitation signal 114 may be generated as a sin wave and another excitation signal generated as a cosine wave. As described hereinbelow, other phase relationships are possible.

The transmitter 110 includes at least one alternating current (AC) source 130 to generate the excitation signals 114 to the touch system 120 where each of the excitation signals in one example are transmitted out of phase with respect to each other excitation signal. At least two of the excitation signals 114 can be generated at the same frequency or at different frequencies with respect to each other via the AC source 130. Different frequencies can be employed for the excitation signals 114 so long as they remain in their given phase relationship (e.g., orthogonal) over the integration time which includes both the time it takes to transmit and receive signals in response to the excitation signals 114.

In one example, at least two of the excitation signals 114 can be transmitted to at least two rows or columns of the touch system 120 where the excitation signals are at least 90 degrees out of phase with respect to each other when transmitted to the respective rows or columns. In other examples, more than two excitation signals 114 can be transmitted to the touch system to further reduce scan time of the touch system. As used herein, the term “scan time” refers to the amount of time it takes to excite each respective row or column of the touch system 120. In single phase excitation systems, each row or column had to be excited individually to detect the presence of a touch shown as user input 134. In the multiphase system described herein, multiple rows or columns can be analyzed concurrently to reduce the scan time in half in a two phase excitation system (or reduced more if more than two excitation signals utilized).

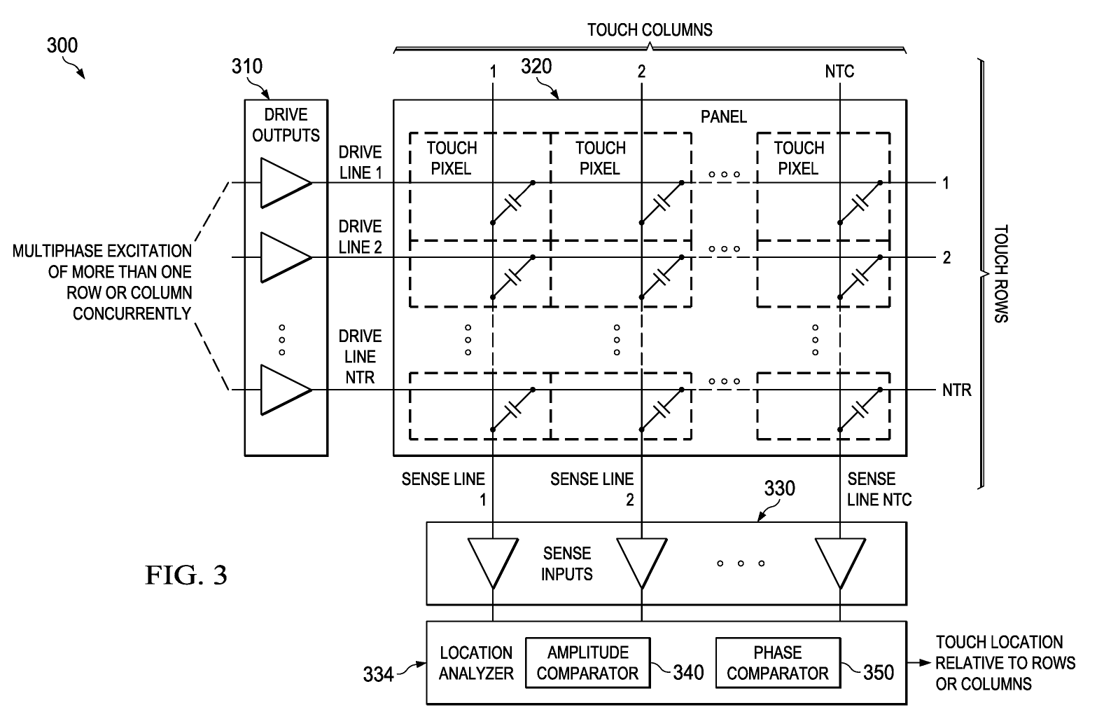

The touch system 120 can be a mutual capacitance touch system (see e.g., FIG. 3) having at least two rows and columns that receive the excitation signals 114 from the transmitter 110 where the touch system generates an output signal 140 (or signals) based on the excitation signals. A receiver 150 receives the output signal 140 from the touch system 120. The receiver 150 includes at least two receiver circuits 160 to process the output signal 140 from the touch system 120 and to determine if or where a user has touched the touch system. As used herein, the term “circuit” can include a collection of active and/or passive elements that perform a circuit function, such as an analog circuit or control circuit. Additionally or alternatively, for example, the term “circuit” can include an integrated circuit (IC) where all and/or some of the circuit elements are fabricated on a common substrate (e.g., semiconductor substrate).

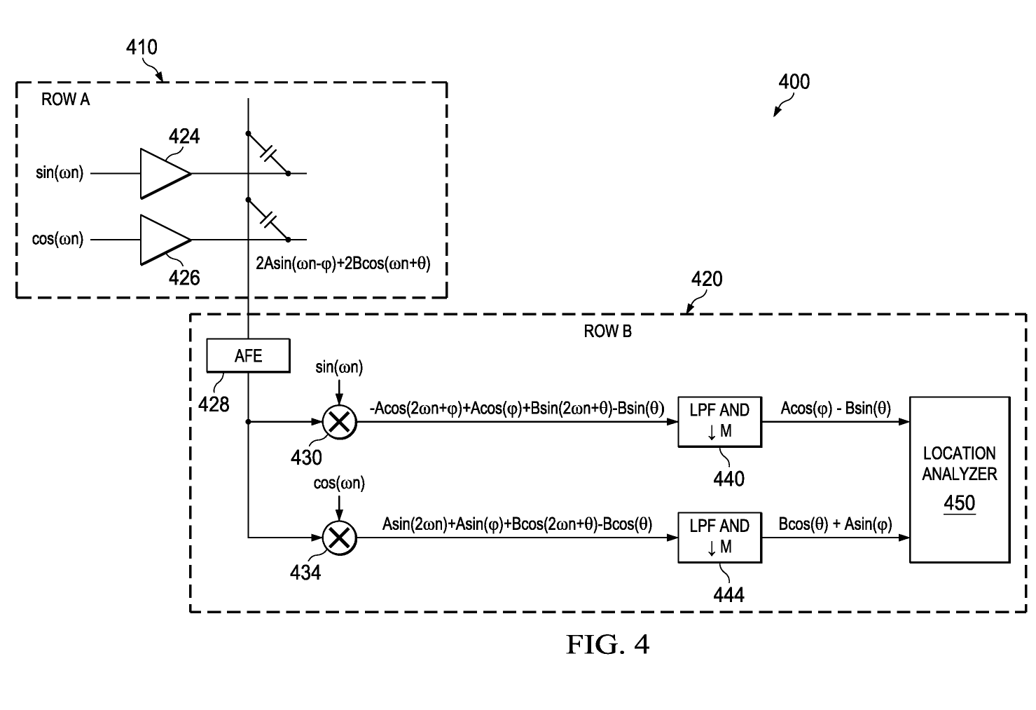

Each of the receiver circuits 160 can include a summing junction (see e.g., FIG. 4) to extrapolate signal phases 170 from the output signal 140 to determine which of the rows or columns was touched from the touch system 120. At one of the summing junctions of the receiver circuits 160, the output signal 140 is summed with the excitation signal at the given phase to extrapolate the row or column excited in response to the given phase. At the other of the summing junctions of the receiver circuits 160, the output signal 140 is summed with the excitation signal at the different phase to extrapolate the row or column excited in response to the different phase. The output of each of the summing junctions can be filtered via a low pass filter to facilitate extrapolating the row or column that was touched from the output of each of the summing junctions in the receiver circuit 160.

By providing multiphase signaling and analysis as described herein to reduce scan time of the touch system, a portion of the touch system 120 can be excited by the transmitter 110 during one scanning sequence and analyzed by the receiver 150 based on the scanning of the portion. At least one other portion of the touch system 120 can be excited by the transmitter 110 during another scanning sequence and analyzed by the receiver based on the scanning of the at least one other portion. In this manner of multiphase signaling and processing, hardware complexity can be reduced because multiple rows or columns can be scanned using fewer connection nodes to the touch system 120 to determine a touch to the system (e.g., in a two phase excitation system, half of the row or column connections from conventional systems can be reduced).

A touch location analyzer 180 compares an amplitude of the output signals received from different rows or columns of the touch system. A ratio of the output signal amplitudes from the different rows or columns of the touch system is utilized to determine the location of the user's touch relative to the rows or columns of the touch system. For example, if the amplitude received from one row was at 20% peak and the amplitude received from another row was at 80% peak, touch location can be calculated base on the ratio of 20/80, such that 80 percent of the users touch force is affecting one row and 20% of the user's touch force is affecting the other row. As used herein, peak signal amplitude refers to the maximum signal received when no touch force is applied. If it is known that 10 millimeters separate the rows for example, the touch location is approximately 8 millimeters away from one row (the 20% peak row) and about two millimeters away from the other row (e.g., 80% peak row).

In another example, received signal phases from different rows or columns of the touch system are analyzed to determine the location of the user's touch. For example, in a no-touch force situation, received output signals may be 90 degrees out of phase with respect to one another. When a user touches the touch system 120, the signal phases of the output signal 140 can change such that it can be determined where in between rows or columns the touch has occurred. A calibration table, described below, can be provided where signal amplitudes and phases are analyzed between maximum touch force and minimum touch force to determine the change in location. The table can include a range of amplitude or phase differences corresponding to how close or near a touch has occurred to a given row or column. By analyzing the respective amplitudes and/or phases received in response to a user's touch of the touch system, precise location of the touch can be determined which includes determining touch locations between rows and/or columns of the touch system. For example, if a stylus (or finger) is placed at a touch location that is directly over a row/column detection point, a maximum signal amplitude may be received for that point. If the stylus is offset to touch/affect more than one row or column detection point of the touch system, a combination of signal amplitudes or phases can be analyzed to detect locations between rows or columns.

In a signal amplitude example, if one row yields a signal amplitude at 50% of maximum, and another row provides a signal that is 50% of maximum, it can be determined from this ratio that the stylus is offset approximately half way between the two rows. A similar analysis can be conducted by the touch location analyzer 180 by comparing signal amplitudes received from respective columns to determine touch locations between columns. In a signal phase example for determining touch location, if a touch location is directly over a row/or column detection point, a given phase may be determined between the respective row or column. If the stylus (or finger) is moved between rows or columns a different phase relationship can be determined. A calibration table in the touch location analyzer 180 can be used to determine a range of amplitudes or phases to be encountered at differing distances between rows or columns of the touch system 120. For example, if a stylus is 100% over a given row of the touch system 120, a phase of 90 degrees may be detected between the two rows. If the stylus is between rows or columns, a phase other than 90 degrees may be detected where this difference in phase from 90 degrees determines the distance between rows or columns.

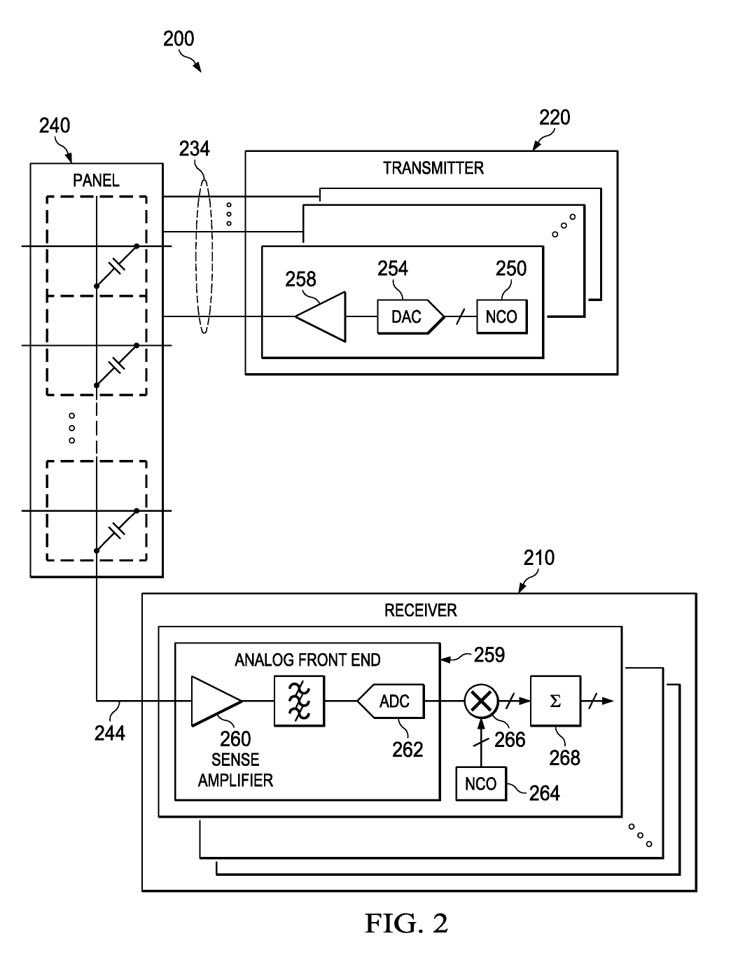

FIG. 2 illustrates an example circuit 200 of a receiver 210 and a transmitter 220 for a touch system where multiphase excitation and processing is employed. The transmitter 220 provides multiple out of phase excitation signals 234 to a touch panel 240. The transmitter 220 can provide row or column excitation to the touch panel 240 to detect a user's touch where more than one row or column are excited concurrently via the excitation signals 234. In this example, a capacitance touch panel 240 is illustrated. In a touch system, mutual or self capacitance can be measured by transmitting the excitation signals 234 to selected rows/columns of the panel 240. The receiver 210 receives a signal 244 in response to the excitation signals 234 applied on the columns/rows of the touch panel 240. When a touch occurs close to a row/column intersection, the received change in signal strength and/or phase change can be detected by the receiver 210. This change isolates the touch location on the touch panel 240.

The transmitter 220 can include at least one numerically controlled oscillator (NCO) 250 which drives a digital to analog converter (DAC) 254, which in turn drives an output amplifier 258 to provide the signals 234. The receiver 210 can include an analog front end 259 that includes an input stage or amplifier 260 which drives an analog to digital converter (ADC) 262. Output from the ADC 262 and NCO 264 can be multiplied at 266 which is then summed at 268. As described hereinbelow with reference to FIG. 4, the receiver 210 can include summing junctions and filters (e.g., before or after the sense amplifier 260) to extrapolate row/column information from the signal 244 as described herein.

FIG. 3 illustrates an example of a touch system 300 that can be excited and analyzed via multiphase signaling. In the touch system 300, a known signal is transmitted via sources which is coupled through a touch panel 320 and then received by the receiver via sense inputs 330. The change in the gain/phase of the received signal from one or more of the sense inputs 330 indicates the presence or absence of a touch. In conventional touch systems, each transmitter (row/drive line) is stimulated, usually with a sinusoidal signal at a known frequency for a certain period of time. The received signal is concurrently measured by a number of receive channels via inputs 330. The change in capacitance on any receive channel indicates the presence of a touch close to the intersection of the transmit channel (row) and that receive channel (column). In such systems, the transmit channels are then scanned row by row to obtain the touch image.

To reduce the area of the touch controller circuit in conventional single excitation systems, one can reduce the number of receive and/or transmit channels. However this increases the scan time. The scan time increases by the same factor as the hardware reduction. For example, if the hardware is reduced by a factor of 2, the scan time increases by a factor 2 to obtain the same performance level. However, an increase in scan time decreases the responsiveness of the touch screen controller. In the system and methods described herein, multiphase signaling is provided where two or more rows/columns of the touch panel 320 are excited concurrently effectively reducing the scan time. When the scan time is reduced, hardware complexity can thereby also be reduced. As shown, a location analyzer 334 can be provided to detect a location for a user's touch via stylus or fingering. The location analyzer 334 can include an amplitude comparator 340 to compare signal amplitudes between rows or columns to determine a signal amplitude ratio which determines touch distances between rows and/or columns. A phase comparator 350 can also be provided to determine touch distances between rows and/or columns based on differences in detected signal phases received.

FIG. 4 illustrates a circuit diagram of an example transmitter 410 and receiver circuit 420 that uses multiphase signaling and processing. In this example, a SIN signal sin(ωn) is transmitted on row 1 via source 424 and a COS signal cos(ωn) on row 2 transmitted concurrently via source 426. Both the SIN and COS can be at the same or different frequencies. When choosing different frequencies, the multiphase signals should remain orthogonal (e.g., in substantially the same phase relationship) over the integration time (transmit and receive time).

At the receiver circuit 420, the received signal represented as 2Asin(ωn+φ)+2Bcos(ωn+θ) in this example, can be received via analog front end (AFE) 428 and can be match filtered with the transmitted SIN and COS signal in the digital domain via summing junctions 430 and 434, respectively. For example, output from the summing junction 430 can be represented as −Acos(2ωn+φ)+Acos(φ)+Bsin(2ωn+θ)-Bsin(θ), and output from the other summing junction can be represented as Asin(2ωn)+Asin(φ)+Bcos(2ωn+θ)+Bcos(θ). These signals can be filtered via low pas filters 440 and 444, respectively to produce output signals Acos(φ)−Bsin(θ) and Bcos(θ)+Asin(φ), respectively. Output from the filters 450 can be analyzed for amplitude and/or phase differences by a location analyzer 450 to determine touch locations between rows or columns of the touch system.

Because the signals can be maintained in a given phase relationship with respect to each other (e.g., orthogonal), changes in the signal strength of the SIN indicates a touch on row 1 and the corresponding receiver while any change in COS will give the touch information on row2 and the receiver of interest. Thus, information about two touch electrodes can be obtained concurrently. This implies that by scanning in pairs, the touch image can be obtained in half the time. As described hereinabove, more than two rows can be concurrently scanned and analyzed. One half the number of receivers can be employed in an example to facilitate scanning the panel twice (e.g., getting half the entire panel information from the first scan and one half from the second scan). Thus, the total scan time using multiphase stimulation remains substantially the same while the hardware complexity is reduced. In some example, the receive channel can be built with a higher dynamic range to account for interference. Therefore, sending multiphase signals does not impact the individual receiver design. Thus, a factor of two hardware improvement can be easily obtained using two excitation signals. This can also be easily extended to larger number of concurrent excitations.

In view of the structural and functional features described hereinabove, an example method is described with reference to FIG. 5. For clarity, the method is shown and described as executing serially, but parts of the method could occur in different orders and/or concurrently from that shown and described herein. Such method can be executed by various components, such as components configured in an integrated circuit, a processor or a controller.

FIG. 5 illustrates an example method 500 to determine touch location of a touch system. At 510, the method 500 includes transmitting excitation signals that are out of phase with respect to each other to a touch system (e.g., via transmitter 110 of FIG. 1). At least one of the excitation signals is transmitted to at least one row or column of the touch system and at least one other of the signals is concurrently transmitted to at least one other row or column of the touch system. At 520, the method 500 includes receiving an output signal from the touch system in response to the excitation signals (e.g., via receiver 150 of FIG. 1). The output signal includes a combined response from two or more rows or columns of the touch system excited by the excitation signals. At 530, the method 500 includes comparing the amplitude or phase of the output signals received from different rows or columns of the touch system to determine a difference in the amplitude or phase of the output signal from the different rows or columns of the touch system to determine the location of the user's touch relative to the rows or columns of the touch system (e.g., via touch location analyzer 180 of FIG. 1). The method 500 can also include transmitting the excitation signals 90 degrees out of phase with respect to each other and/or at different frequencies with respect to each other.

Modifications are possible in the described embodiments, and other embodiments are possible, within the scope of the claims.

1. A system, comprising:
a receiver to receive output signals from a touch system to detect a user's touch, the output signals received in response to excitation signals that are generated out of phase with respect to each other and concurrently applied to at least two rows or columns of the touch system; and
a touch location analyzer to compare an amplitude of the output signals received from the at least two rows or columns of the touch system, wherein a ratio of the output signal amplitudes from the at least two rows or columns of the touch system is utilized to determine a location of the user's touch relative to the rows or columns of the touch system, the comparison of amplitude comparing the amplitude of at least a first received output signal from a first selected row or column that receives concurrent excitation signals applied to at least two rows or columns of the touch system to the amplitude of at least a second selected row or column different from the first selected row or column that receives concurrent excitation signals applied to at least two rows or columns if the touch system.

2. The system of claim 1, further comprising a transmitter that includes at least one alternating current (AC) source to generate excitation signals to the touch system.

3. The system of claim 2, wherein at least two of the excitation signals are generated at the same frequency or at different frequencies with respect to each other via the output signal AC source.

4. The system of claim 2, wherein at least two of the excitation signals are transmitted to at least two rows or columns of the touch system, the excitation signals are about 90 degrees out of phase with respect to each other when transmitted to the respective rows or columns.

5. The system of claim 2, further comprising a mutual capacitance touch system having at least two rows and columns that receive the excitation signals from the transmitter, wherein the touch system generates an output signal based on the excitation signals.

6. The system of claim 1, wherein the receiver includes at least two receiver circuits to process the output signal from the touch system.

7. The system of claim 6, wherein each of the at least two receiver circuits include a summing junction to extrapolate signal phases from the output signals to determine which of the at least two rows or columns was touched, wherein at one of the summing junctions of the at least two receiver circuits a respective output signal is summed with the excitation signal at a given phase to extrapolate the row or column excited in response to the given phase, and at the other of the summing junctions of the at least two receiver circuits another respective output signal is summed with the excitation signal at a different phase to extrapolate the row or column excited in response to the different phase.

8. The system of claim 7, wherein a portion of the touch system is excited during one scanning sequence and analyzed by the receiver based on the scanning of the portion, and at least one other portion of the touch system is excited by during another scanning sequence and analyzed by the receiver based on the scanning of the at least one other portion.

9. The system of claim 7, wherein the touch location analyzer compares the phase of the output signals received from different rows or columns of the touch system, wherein a difference in phase of the output signal amplitudes from the different rows or columns of the touch system is utilized to determine the location of the user's touch relative to the rows or columns of the touch system.

10. A system, comprising:
a receiver to receive output signals from a touch system to detect a user's touch, the output signals received in response to at least two out of phase excitation signals concurrently applied to at least two rows or columns of the touch system; and
a touch location analyzer to compare the phase of the output signals received from different rows or columns of the touch system, wherein a difference in phase of the received output signals from the rows or columns of the touch system is utilized to determine a location of the user's touch relative to the rows or columns of the touch system, wherein the difference in phase is determined by comparing a phase of a first received output signal from a first row or column of the touch system that is received in response to the concurrent application of the out of phase excitation signals to at least two rows or columns of the touch system to the phase of a second received output signal from a second row or column of the touch system different from the first row or column that is received in response to the concurrent application of the output of phase excitation signals to at least two rows or columns of the touch system.

11. The system of claim 10, further comprising a transmitter to generate the at least two out of phase excitation signals, wherein the transmitter includes at least one alternating current (AC) source to generate the excitation signals to the touch system, each of the out of phase excitation signals are orthogonal with respect to each other.

12. The system of claim 11, wherein the at least two excitation signals are generated at the same frequency or at different frequencies with respect to each other via the AC source.

13. The system of claim 11, wherein the at least two excitation signals are transmitted to at least two rows or columns of the touch system, the excitation signals are about 90 degrees out of phase with respect to each other when transmitted to the respective rows or columns.

14. The system of claim 10, further comprising a mutual capacitance touch system having at least two rows and columns that receive the excitation signals, wherein the touch system generates an output signal in response to the excitation signals.

15. The system of claim 14, wherein each of the at least two receiver circuits include a summing junction to extrapolate signal phases from the output signal to determine which of the at least two rows or columns was touched, wherein at one of the summing junctions of the at least two receiver circuits the output signal is summed with the excitation signal at a given phase to extrapolate the row or column excited in response to the given phase, and at the other of the summing junctions of the at least two receiver circuits the output signal is summed with the excitation signal at a different phase to extrapolate the row or column excited in response to the different phase.

16. The system of claim 15, wherein a portion of the touch system is excited during one scanning sequence and analyzed by the receiver based on the scanning of the portion, and at least one other portion of the touch system is excited during another scanning sequence and analyzed by the receiver based on the scanning of the at least one other portion.

17. The system of claim 10, wherein the touch location analyzer compares an amplitude of the output signals received from different rows or columns of the touch system, wherein a ratio of the output signal amplitudes from the different rows or columns of the touch system is utilized to determine the location of the user's touch relative to the rows or columns of the touch system.

18. A method, comprising:
transmitting excitation signals that are out of phase with respect to each other to a touch system, at least one of the excitation signals transmitted to at least one row or column of the touch system and at least one other of the excitation signals concurrently transmitted to at least one other row or column of the touch system;
receiving output signals from the touch system in response to the excitation signals, wherein the output signal includes a combined response from two or more rows or columns of the touch system excited by the excitation signals; and
comparing amplitude or phase of the output signals received from different rows or columns of the touch system to determine a difference in the amplitude or phase of the output signals from the different rows or columns of the touch system to determine a location of a user's touch relative to the rows or columns of the touch system, the comparing by comparing the amplitude or phase of a first received signal received from a row or column in the touch system in response to the concurrent application of the excitation signals to at least two rows or columns of the touch system to the amplitude or phase of a second received signal received from another row or column in the touch system in response to the concurrent application of the excitation signals to at least two rows or columns of the touch system.

19. The method of claim 18, further comprising transmitting the excitation signals to at least two rows or columns of the touch system, the excitation signals are generated at the same frequency or at different frequencies with respect to each other.

20. The method of claim 19, further comprising transmitting the excitation signals to at least two rows or columns of the touch system, the excitation signals are about 90 degrees out of phase with respect to each other when transmitted to the respective rows or columns.
